(19) United States
(12) Patent Application Publication
(10) Pub. No.: US 2024/0064880 A1
(43) Pub. Date: Feb. 22, 2024

(54) COOKING DEVICE AND COOKING DEVICE CONTROL METHOD

(71) Applicant: LG ELECTRONICS INC., Seoul (KR)

(72) Inventors: So Young PARK, Seoul (KR); Go Eun LEE, Seoul (KR); Eunmi SHIN, Seoul (KR); Boram KWON, Seoul (KR)

(73) Assignee: LG ELECTRONICS INC., Seoul (KR)

(21) Appl. No.: 18/271,409

(22) PCT Filed: Jan. 7, 2022
(86) PCT No.: PCT/KR2022/000333

§ 371 Date: Jul. 7, 2023

(30) Foreign Application Priority Data
Jan. 8, 2021 (KR) 10-2021-0002350

(51) Int. Cl. H05B 6/64; H05B 1/02

(52) U.S. Cl. CPC H05B 6/6447; H05B 1/0263

(57) ABSTRACT

A cooking device according to one embodiment of the present specification comprises: a cooking chamber having a plurality of levels at which cooking vessels can be accommodated; a magnetron for supplying microwaves into the cooking chamber; a heater for applying heat to the inside of the cooking chamber; a communication unit for receiving, from a server, recipe information matched with identification information for a product inputted through a user terminal; an input unit for receiving, from a user, an input of selecting any one piece of prestored recipe information about one or more products; a control unit for controlling the operation of the magnetron and the heater on the basis of the recipe information received from the communication unit or the recipe information selected by means of the input unit; and a display unit for displaying the type of cooking vessel and the position of the cooking vessel on the basis of the recipe information received from the communication unit or the recipe information selected by means of the input unit.

### TECHNICAL FIELD

The present specification relates to a cooking device and a control method of the cooking device.

### BACKGROUND ART

A cooking device is a device for cooking food using the heat of a heating source. A cooking device may include a heating source for heating food accommodated in a cooking chamber. Such a cooking device may include various types of heating sources such as a magnetron and a heater. Since the cooking device may include various types of heating sources, a user may cook in various ways using the cooking device.

However, since cooking in various ways has become possible, there is an inconvenience that, every time a user cooks a commercially available product using the cooking device, the user should check the cooking method of the corresponding product one by one and operate the cooking device.

In order to solve such an inconvenience, as in Korean Patent Publication No. 10-2012-0117463, a technology for recommending a cooking method based on recognizing a product to be cooked with a recognition device has been developed.

Such a technology recommends the same cooking method for products in the same category of objects to be cooked. For example, when a product to be cooked by a user is a product in the fried rice category, the same type of cooking method is recommended regardless of conditions required in a final cooking result, that is, regardless of whether the product to be cooked is egg fried rice, vegetable fried rice, or the like.

Therefore, there is a need to develop a cooking device and a control method of the cooking device capable of addressing such a problem.

### DISCLOSURE

### Technical Problem

The present specification is directed to providing a cooking device and a control method of the cooking device allowing different types of cooking methods to be used even for products in the same category.

Objectives of the present specification are not limited to the above-mentioned objective, and other unmentioned objectives of the present specification and advantages thereof may be understood by the description below and should be more clearly understood from embodiments of the present specification. Also, it should be easily understood that the objectives and advantages of the present specification may be realized by means described in the claims below and combinations thereof.

### Technical Solution

In one embodiment of the present specification, a controller and a display of a cooking device perform different operations according to the type of recipe information.

According to such a configuration, different types of cooking methods may be used even for products in the same category.

One embodiment of the present specification provides a cooking device including a cooking chamber having a plurality of stages formed to store a cooking container, a magnetron configured to supply microwaves to an inside of the cooking chamber, a heater configured to apply heat to the inside of the cooking chamber, a communication device configured to receive, from a server, recipe information that matches product identification information input through a user terminal, an input device configured to receive an input selecting any one of pieces of pre-stored recipe information of one or more products from a user, a controller configured to control operations of the magnetron and the heater based on the recipe information received through the communication device or the recipe information selected through the input device, and a display configured to display a type of the cooking container and a position of the cooking container based on the recipe information received through the communication device or the recipe information selected through the input device.

Also, in one embodiment of the present specification, the controller of the cooking device may control the magnetron and the heater to operate in a case in which the recipe information received through the communication device or the recipe information selected through the input device is recipe information of a product not requiring moisture.

Also, in one embodiment of the present specification, the display of the cooking device may display a heat-conducting coated container as the type of the cooking container in the case in which the recipe information received through the communication device or the recipe information selected through the input device is recipe information of a product not requiring moisture.

Also, in one embodiment of the present specification, the display of the cooking device may display an uppermost stage among the plurality of stages as the position of the cooking container in the case in which the recipe information received through the communication device or the recipe information selected through the input device is recipe information of a product not requiring moisture.

Also, in one embodiment of the present specification, the controller of the cooking device may control the magnetron to operate but the heater to not operate in a case in which the recipe information received through the communication device or the recipe information selected through the input device is recipe information of a product requiring moisture.

Also, in one embodiment of the present specification, the display of the cooking device may display a grill or an enameled container as the type of the cooking container in the case in which the recipe information received through the communication device or the recipe information selected through the input device is recipe information of a product requiring moisture.

Also, in one embodiment of the present specification, the display of the cooking device may display a lowermost stage among the plurality of stages as the position of the cooking container in the case in which the recipe information received through the communication device or the recipe information selected through the input device is recipe information of a product requiring moisture.

Also, in one embodiment of the present specification, the display of the cooking device may additionally display a cooking container cover guide phrase in the case in which the recipe information received through the communication device or the recipe information selected through the input device is recipe information of a product requiring moisture.

Another embodiment of the present specification provides a control method of a cooking device including a cooking chamber having a plurality of stages formed to store a cooking container, a magnetron configured to supply microwaves to an inside of the cooking chamber, a heater configured to apply heat to the inside of the cooking chamber, a communication device, an input device, a controller, and a display, the control method including an operation in which the communication device receives, from a server, recipe information that matches product identification information input through a user terminal, an operation in which the input device receives an input selecting any one of pieces of pre-stored recipe information of one or more products from a user, an operation in which the controller controls operations of the magnetron and the heater based on the recipe information received through the communication device or the recipe information selected through the input device, and an operation in which the display displays a type of cooking container and a position of the cooking container based on the recipe information received through the communication device or the recipe information selected through the input device.

Also, in another embodiment of the present specification, the operation of the control method of the cooking device in which the controller controls the operations of the magnetron and the heater may include an operation in which the controller controls the magnetron and the heater to operate in a case in which the recipe information received through the communication device or the recipe information selected through the input device is recipe information of a product not requiring moisture.

Also, in another embodiment of the present specification, the operation of the control method of the cooking device in which the display displays the type of the cooking container and the position of the cooking container may include an operation in which the display displays a heat-conducting coated container as the type of the cooking container in the case in which the recipe information received through the communication device or the recipe information selected through the input device is recipe information of a product not requiring moisture.

Also, in another embodiment of the present specification, the operation of the control method of the cooking device in which the display displays the type of the cooking container and the position of the cooking container may include an operation in which the display displays an uppermost stage among the plurality of stages as the position of the cooking container in the case in which the recipe information received through the communication device or the recipe information selected through the input device is recipe information of a product not requiring moisture.

Also, in another embodiment of the present specification, the operation of the control method of the cooking device in which the controller controls the operations of the magnetron and the heater may include an operation in which the controller controls the magnetron to operate but the heater to not operate in a case in which the recipe information received through the communication device or the recipe information selected through the input device is recipe information of a product requiring moisture.

Also, in another embodiment of the present specification, the operation of the control method of the cooking device in which the display displays the type of the cooking container and the position of the cooking container may include an operation in which the display displays a grill or an enameled container as the type of the cooking container in the case in which the recipe information received through the communication device or the recipe information selected through the input device is recipe information of a product requiring moisture.

Also, in another embodiment of the present specification, the operation of the control method of the cooking device in which the display displays the type of the cooking container and the position of the cooking container may include an operation in which the display displays a lowermost stage among the plurality of stages as the position of the cooking container in the case in which the recipe information received through the communication device or the recipe information selected through the input device is recipe information of a product requiring moisture.

Also, in another embodiment of the present specification, the operation of the control method of the cooking device in which the display displays the type of the cooking container and the position of the cooking container may include an operation in which the display additionally displays a cooking container cover guide phrase in the case in which the recipe information received through the communication device or the recipe information selected through the input device is recipe information of a product requiring moisture.

### Advantageous Effects

A cooking device and a control method of the cooking device according to the present specification have an advantage that, due to performing different operations according to the type of recipe information, different types of cooking methods can be used even for products in the same category.

### DESCRIPTION OF DRAWINGS

FIG. 1 is a view illustrating a system in which a cooking device and a control method of the cooking device according to one embodiment of the present specification may be used.

FIG. 2 is a view illustrating the cooking device according to one embodiment of the present specification.

FIG. 3 is a block diagram illustrating the cooking device according to one embodiment of the present specification.

FIG. 4 is a flowchart illustrating the control method of the cooking device according to one embodiment of the present specification.

FIG. 5 is a view illustrating a screen displayed by a display of the cooking device according to one embodiment of the present specification in a case in which recipe information is recipe information of a product not requiring moisture.

FIG. 6 is a view illustrating a screen displayed by the display of the cooking device according to one embodiment of the present specification in a case in which recipe information is recipe information of a product requiring moisture.

FIG. 7 is a table showing objects operated by a controller of the cooking device according to one embodiment of the present specification and content displayed by the display of the cooking device according to the type of product.

### MODES OF THE INVENTION

The objectives, features, and advantages will be described in detail below with reference to the accompanying drawings, and accordingly, those of ordinary skill in the art to which the present specification pertains should be able to easily practice the technical idea of the present specification. In describing the present specification, when it is determined that detailed description of a known art related to the present specification may unnecessarily obscure the gist of the present specification, the detailed description thereof will be omitted. Hereinafter, exemplary embodiments according to the present specification will be described in detail with reference to the accompanying drawings. In the drawings, the same reference numerals are used to indicate the same or similar components.

Although terms such as first and second are used to describe various components, of course, the components are not limited by the terms. The terms are only used to distinguish one component from another component, and of course, a first component may also be a second component unless otherwise stated.

Hereinafter, when an arbitrary configuration is described as being disposed on an “upper portion (or lower portion)” of a component or being disposed “on (or under)” the component, this may not only mean that the arbitrary configuration is disposed in contact with an upper surface (or lower surface) of the component but may also mean that another configuration may be interposed between the component and the arbitrary configuration disposed on (or under) the component.

Also, when a certain component is described as being “connected,” “coupled,” or “linked” to another component, this may mean that the component is directly connected or linked to the other component but may also mean that the component is “connected,” “coupled,” or “linked” to the other component via another component “interposed” therebetween or the component and the other component are “connected,” “coupled,” or “linked” through other components.

Throughout the specification, unless otherwise stated, the number of each component may be singular or plural.

A singular expression used in one embodiment of the present specification includes a plural expression unless the context clearly indicates otherwise. In this application, terms such as “consist of” or “include” should not be construed as indicating that all of various components or various operations described herein are necessarily included, and should be construed as indicating that some components or some operations may not be included or additional components or operations may be further included.

Hereinafter, a cooking device and a control method of the cooking device according to some embodiments of the present specification will be described.

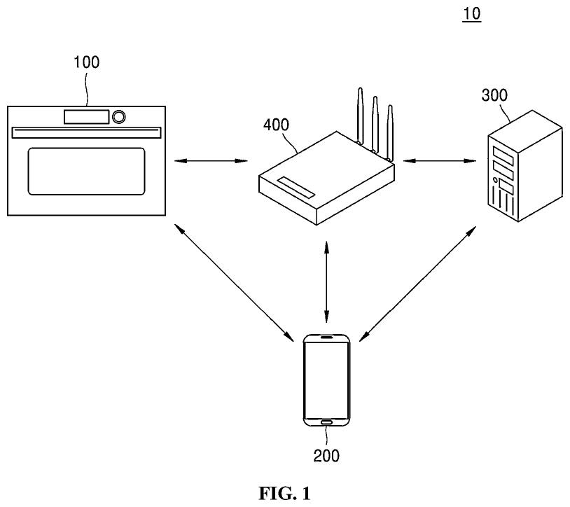

FIG. 1 is a view illustrating a system in which a cooking device and a control method of the cooking device according to one embodiment of the present specification may be used.

Referring to FIG. 1, a system 10 in which a cooking device and a control method of the cooking device may be used may include a cooking device 100, a user terminal 200, a server 300, and a router 400.

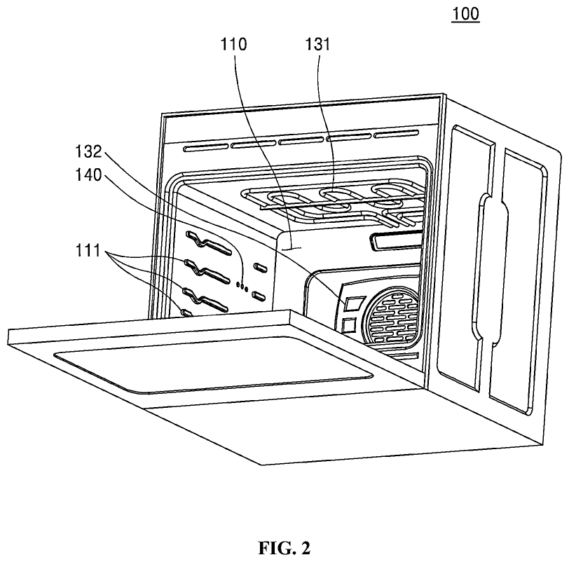

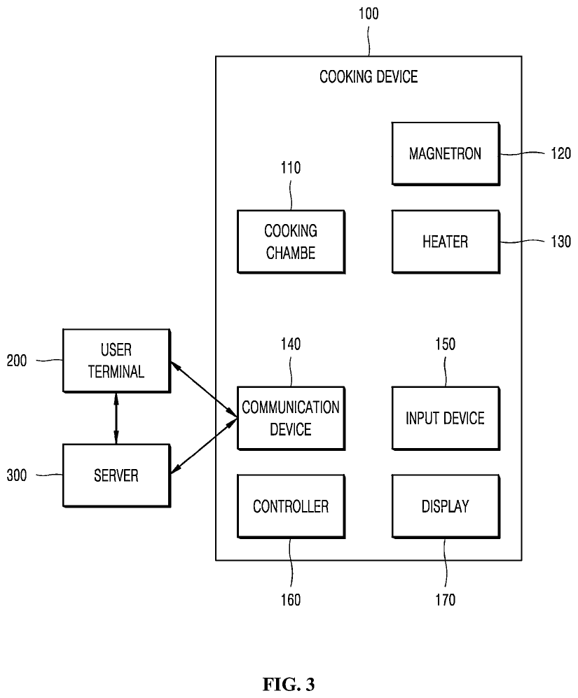

The cooking device 100 is a device for cooking food. The structure and control method of the cooking device 100 will be described below with reference to FIGS. 2 and 3.

The user terminal 200 is an arbitrary terminal including a processor for processing or operating an instruction, a display for displaying various pieces of information, a voice input device (e.g., a microphone) that may receive a voice of a user, a voice output device (e.g., a speaker) that may output a voice, an imaging device (e.g., a camera) that may obtain an image of an object placed outside, and a communication module that may perform a function of communicating with another device. Examples of the user terminal 200 may include a mobile terminal such as a smartphone, a tablet, a desktop, and a laptop, but the scope of the user terminal 200 is not limited thereto. Hereinafter, the case in which the user terminal 200 is a smartphone will be used as an example in describing embodiments of the present specification.

The server 300 performs communication with the cooking device 100 or the user terminal 200. Here, the server 300 may perform communication with the cooking device 100 or the user terminal 200 through the router 400. The server 300 may transmit information to the cooking device 100 or the user terminal 200 based on information or a request received from the cooking device 100 or the user terminal 200.

Also, the server 300 may transmit information received from the cooking device 100 relating to an operational state of the cooking device 100 to the user terminal 200. In this way, the user may remotely check a state of the cooking device 100 and remotely control the cooking device 100 through the user terminal 200.

The router 400 is connected to a communication line installed in places such as a home or office and sends a wireless signal. The cooking device 100 and the user terminal 200 are present within a range in which the cooking device 100 and the user terminal 200 may receive a wireless signal from the router 400. The router 400 receives a wireless signal sent from devices connected to communicate with the router 400, for example, the cooking device 100 and the user terminal 200, and transmits the received wireless signal to the outside through a communication line, or converts a signal input from the outside through a communication line into a wireless signal and transmits the wireless signal. Accordingly, the cooking device 100 connected to the router 400 may perform communication with the server 300.

FIG. 2 is a view illustrating the cooking device according to one embodiment of the present specification. FIG. 3 is a block diagram illustrating the cooking device according to one embodiment of the present specification.

Referring to FIGS. 2 and 3, the cooking device 100 according to one embodiment of the present specification includes a cooking chamber 110, a magnetron 120, a heater 130, a communication device 140, an input device 150, a controller 160, and a display 170.

The cooking chamber 110 is a space accommodating an object to be cooked. The cooking chamber 110 may be formed inside a case forming an exterior of the cooking device 100.

A plurality of stages 111 in which a cooking container may be stored are formed in the cooking chamber 110. The plurality of stages 111 are formed at both side surfaces of the cooking chamber 110 and allow a cooking container to be placed at different heights.

In one embodiment of the present specification, the plurality of stages 111 may be made of a total of four stages as illustrated in FIG. 2 and may include a first stage closest to a bottom surface of the cooking chamber 110, a second stage placed right above the first stage, a third stage placed right above the second stage, and a fourth stage placed right above the third stage and closest to a ceiling surface of the cooking chamber 110. Hereinafter, description will be given based on the case in which the plurality of stages 111 are provided as a total of four stages as in the above-described embodiment.

The magnetron 120 supplies microwaves to the inside of the cooking chamber 110. The magnetron 120 may be placed on any of a side surface, a rear surface, and the ceiling surface of the cooking chamber 110.

The heater 130 applies heat to the inside of the cooking chamber 110.

The heater 130 includes a first heater 131 configured to apply heat to the inside of the cooking chamber 110 from one side of the cooking chamber 110 and a second heater 132 configured to apply heat to the inside of the cooking chamber 110 from the other side of the cooking chamber 110.

In one embodiment of the present specification, as illustrated in FIG. 2, the first heater 131 may be an upper heater disposed on the ceiling surface of the cooking chamber 110, and the second heater 132 may be a rear heater disposed on the rear surface of the cooking chamber 110.

The communication device 140 receives, from the server 300, recipe information that matches product identification information input through the user terminal 200.

Hereinafter, a product refers to an object to be cooked using the cooking device 100 after being bought from stores such as a marts and convenience stores by a user and may include food that may be eaten after being easily cooked using the cooking device 100, such as dumplings, pizza, and fried rice. Here, a package of a product may include unique identification information such as a barcode, a quick response (QR) code, and a radio frequency identification (RFID) tag.

Product identification information is information allowing a specific product to be identified from another product and may include at least one of a barcode, a QR code, an RFID tag, and a product image included on a package of the product.

The user may input product identification information to the user terminal 200 to eventually allow the cooking device 100 to recognize a product to be cooked.

More specifically, the user may input product identification information using a camera of the user terminal 200. Then, the user terminal 200 may transmit the product identification information to the server 300.

The server 300 may transmit recipe information matching the product identification information received from the user terminal 200 to the cooking device 100.

Recipe information is information relating to a method of cooking a product using the cooking device 100 and may include information such as whether the magnetron 120 and the heater 130 operate, operation times of the magnetron 120 and the heater 130, a type of cooking container, a position of the cooking container, and the like.

The server 300 may, upon receiving product identification information from the user terminal 200, transmit recipe information matching the product identification information to the cooking device 100. Accordingly, the communication device 140 may receive the recipe information from the server 300.

The input device 150 receives an input from the user. The input device 150 may receive various types of inputs relating to the operation of the cooking device 100 from the user. Also, the input device 150 may receive an input selecting any one of pieces of pre-stored recipe information of one or more products from the user. That is, pieces of recipe information of one or more products may be stored in the cooking device 100, and the cooking device 100 may receive a selection on recipe information through the input device 150.

The controller 160 controls the overall operation of the cooking device 100. The controller 160 controls the operations of the magnetron 120 and the heater 130 based on recipe information received through the communication device 140 or recipe information selected through the input device 150.

The display 170 displays a type of cooking container and a position of the cooking container that are included in recipe information.

A type of cooking container is a type of cooking container suitable for holding an object to be cooked when cooking the corresponding product. Also, a position of the cooking container is a position suitable for placing the cooking container when cooking the corresponding product and may be any one of the plurality of stages 111 formed in the cooking chamber 110.

In this way, by guiding a type of cooking container and a position of the cooking container to the user, the display 170 can eliminate the need for the user to separately figure out a type of cooking container that should be used when cooking the corresponding product and a stage on which the cooking container should be placed when cooking the corresponding product.

Here, a method in which the controller 160 controls the operations of the magnetron 120 and the heater 130 and a type of cooking container and a position of the cooking container displayed by the display 170 may be set differently based on whether recipe information is recipe information of a product not requiring moisture or a product requiring moisture.

A product not requiring moisture is a product whose texture is further enhanced when moisture is not contained in the final cooked product upon the completion of cooking of the product using the cooking device 100. Examples of the product not requiring moisture may include products such as typical fried rice or pilaf.

A product requiring moisture is a product whose texture is further enhanced when moisture is contained in the final cooked product upon the completion of cooking of the product using the cooking device 100. Examples of the product requiring moisture may include products such as fried rice with vegetables or bibimbap.

First, in a case in which recipe information received through the communication device 140 or recipe information selected through the input device 150 is recipe information of a product not requiring moisture, the controller 160 may control the magnetron 120 and the heater 130 to operate. That is, the controller 160 may heat a product using the magnetron 120 and the heater 130 so that moisture contained in the product evaporates, and the product has a better texture. For example, in a case in which a product to be cooked is typical fried rice, the controller 160 may heat the product using the magnetron 120 and the heater 130 and cause moisture in the product to evaporate, thus making the fried rice have a slightly dry texture.

Also, in the case in which recipe information received through the communication device 140 or recipe information selected through the input device 150 is recipe information of a product not requiring moisture, the display 170 may display a heat-conducting coated container as a type of cooking container. Here, the heat-conducting coated container may be a Teflon-coated container made of aluminum metal. That is, the display 170 may guide the user to use the heat-conducting coated container as a cooking container so that heat is more easily transferred to an object to be cooked, thus allowing moisture in the object to be cooked to more effectively evaporate.

Also, in the case in which recipe information received through the communication device 140 or recipe information selected through the input device 150 is recipe information of a product not requiring moisture, the display 170 may display an uppermost stage among the plurality of stages 111 as the position of the cooking container. That is, the display 170 designates the position of the cooking container so that the user places the cooking container on the uppermost stage among the plurality of stages 111 that is adjacent to the upper heater 131, in other words, a distance between the cooking container and the upper heater 131 is minimized. Accordingly, since heat is more easily applied to the object to be cooked, moisture in the object to be cooked can more effectively evaporate.

Conversely, in a case in which recipe information received through the communication device 140 or recipe information selected through the input device 150 is recipe information of a product requiring moisture, the controller 160 may control the magnetron 120 to operate but the heater 130 to not operate. That is, the controller 160 may heat a product using only the magnetron 120 and thus prevent evaporation of moisture that may occur due to application of heat by the heater 130. For example, in a case in which a product to be cooked is fried rice with vegetables, the controller 160 may heat the product using only the magnetron 120 and minimize evaporation of moisture, thus preventing the vegetables in the fried rice from becoming dry.

Also, in the case in which recipe information received through the communication device 140 or recipe information selected through the input device 150 is recipe information of a product requiring moisture, the display 170 may display a grill or an enameled container as a type of cooking container. That is, by guiding the user to use a grill or an enameled container, having lower thermal conductivity than the heat-conducting coated container, as the cooking container, the display 170 can prevent evaporation of moisture that may occur due to application of excessive heat to the object to be cooked.

Also, in the case in which recipe information received through the communication device 140 or recipe information selected through the input device 150 is recipe information of a product requiring moisture, the display 170 may display a lowermost stage among the plurality of stages 111 as the position of the cooking container. That is, the display 170 designates the position of the cooking container so that the user places the cooking container on the lowermost stage among the plurality of stages 111 that is the farthest from the upper heater 131, in other words, a distance between the cooking container and the upper heater 131 is maximized. Accordingly, evaporation of moisture that may occur due to application of heat remaining in the upper heater 131 to the object to be cooked can be prevented.

Also, in the case in which recipe information received through the communication device 140 or recipe information selected through the input device 150 is recipe information of a product requiring moisture, the display 170 may additionally display a cooking container cover guide phrase. That is, by guiding the user to cover the cooking container with a wrap, a lid, or the like, the display 170 can prevent evaporation of moisture to the outside of the object to be cooked.

In this way, since the cooking device 100 according to the present specification performs different operations according to whether recipe information is recipe information of a product not requiring moisture or recipe information of a product requiring moisture, different types of cooking methods can be used even for products in the same category.

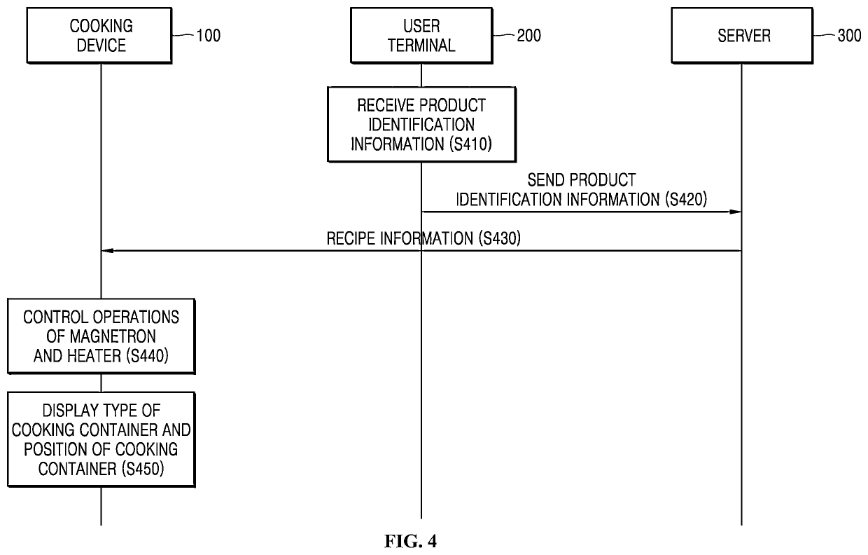

FIG. 4 is a flowchart illustrating the control method of the cooking device according to one embodiment of the present specification.

Referring to FIG. 4, first, the user terminal 200 receives product identification information (S410). That is, the user inputs product identification information using an imaging device of the user terminal 200.

In one embodiment of the present specification, the user may run an application for controlling the cooking device 100 in the user terminal 200 and then input product identification information using the imaging device of the user terminal 200.

Once the product identification information is input, the user terminal 200 sends the product identification information to the server 300 (S420). Accordingly, the server 300 receives the product identification information.

The server 300 searches for recipe information matching the product identification information and then transmits the found recipe information to the cooking device 100 (S430). Accordingly, the user terminal 200 receives the recipe information.

Once the recipe information is received, the controller 160 controls the magnetron 120 and the heater 130 (S440). Here, in a case in which recipe information received through the communication device 140 is recipe information of a product not requiring moisture, the controller 160 may control the magnetron 120 and the heater 130 to operate. Also, in a case in which recipe information received through the communication device 140 is recipe information of a product requiring moisture, the controller 160 may control the magnetron 120 to operate but the heater 130 to not operate.

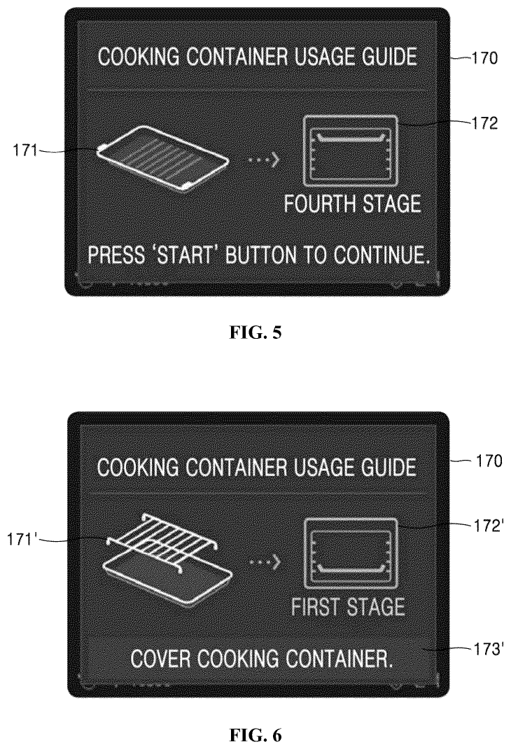

Also, the display 170 displays a type of cooking container and a position of the cooking container (S460). One embodiment of a screen displayed by the display 170 will be described in more detail with reference to FIGS. 5 and 6.

FIG. 5 is a view illustrating a screen displayed by the display of the cooking device according to one embodiment of the present specification in a case in which recipe information is recipe information of a product not requiring moisture.

Referring to FIG. 5, the display 170 may display a cooking container type 171 on a left side of a screen and display a cooking container position 172 on a right side of the screen.

Here, in a case in which recipe information received through the communication device 140 is recipe information of a product not requiring moisture, the display 170 may display a heat-conducting coated container as the cooking container type 171. In one embodiment of the present specification, the display 170 may display the cooking container type 171 using an icon corresponding to the heat-conducting coated container.

Also, in the case in which recipe information received through the communication device 140 is recipe information of a product not requiring moisture, the display 170 may display the uppermost stage among the plurality of stages 111 as the cooking container position 172. In one embodiment of the present specification, the display 170 may display the cooking container position 172 by displaying an icon indicating the uppermost stage among the plurality of stages 111 and the name of the uppermost stage (for example, fourth stage).

FIG. 6 is a view illustrating a screen displayed by the display of the cooking device according to one embodiment of the present specification in a case in which recipe information is recipe information of a product requiring moisture.

Referring to FIG. 6, the display 170 may display a cooking container type 171′ on a left side of a screen and display a cooking container position 172′ on a right side of the screen.

Here, in a case in which recipe information received through the communication device 140 is recipe information of a product requiring moisture, the display 170 may display a grill or an enameled container as the cooking container type 171′. In one embodiment of the present specification, the display 170 may display the cooking container type 171′ using an icon corresponding to the grill or enameled container.

Also, in the case in which recipe information received through the communication device 140 is recipe information of a product requiring moisture, the display 170 may display the lowermost stage among the plurality of stages 111 as the cooking container position 172′. In one embodiment of the present specification, the display 170 may display the cooking container position 172′ by displaying an icon indicating the lowermost stage among the plurality of stages 111 and the name of the lowermost stage (for example, first stage).

Also, in the case in which recipe information received through the communication device 140 is recipe information of a product requiring moisture, the display 170 may additionally display a cooking container cover guide phrase 173′. In one embodiment of the present specification, the display 170 may additionally display a phrase such as “Cover the cooking container” as the cooking container cover guide phrase 173′.

Referring back to FIG. 4, in this way, the display 170 may display a type of cooking container and a position of the cooking container to the user.

The embodiment in which the user inputs product identification information using the user terminal 200, the cooking device 100 receives recipe information, and the controller 160 and the display 170 operate based on the received recipe information is illustrated in FIG. 4, but the present specification is not limited thereto. That is, the embodiment in which the user selects recipe information using the input device 150, and the controller 160 and the display 170 operate based on the selected recipe information also belongs to the scope of the present specification.

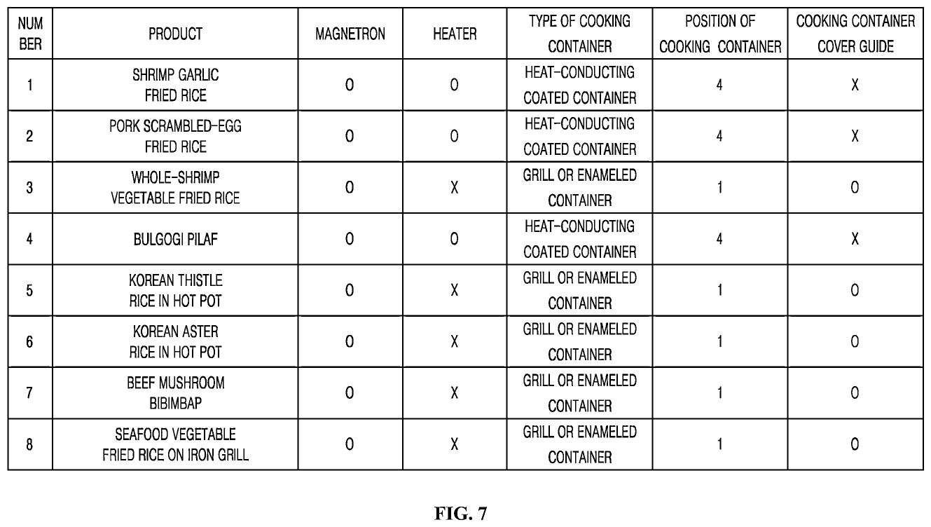

FIG. 7 is a table showing objects operated by the controller of the cooking device according to one embodiment of the present specification and content displayed by the display of the cooking device according to the type of product.

FIG. 7 shows a table showing whether the magnetron 120 and the heater 130 operate, the type of cooking container, the position of the cooking container, and whether a cooking container cover guide phrase is displayed, according to the product cooked using the cooking device 100.

Here, the table of FIG. 7 is created based on whether each product is a product not requiring moisture or a product requiring moisture. Also, recipe information may be generated based on the table of FIG. 7.

In the table of FIG. 7, shrimp garlic fried rice, pork scrambled-egg fried rice, and bulgogi pilaf are products that need a slightly dry texture rather than a moist texture after being cooked. Therefore, shrimp garlic fried rice, pork scrambled-egg fried rice, and bulgogi pilaf may be included in products not requiring moisture. Therefore, recipe information of shrimp garlic fried rice, pork scrambled-egg fried rice, and bulgogi pilaf may include content that recommends controlling the magnetron 120 and the heater 130 to operate by the controller 160, displaying a heat-conducting coated container as the type of cooking container by the display 170, and displaying the uppermost stage among the plurality of stages 111 as the position of the cooking container by the display 170.

Also, in the table of FIG. 7, whole-shrimp vegetable fried rice, Korean thistle rice in a hot pot, beef mushroom bibimbap, and seafood vegetable fried rice on an iron grill are products that may taste better when the vegetables included in the products are not dry after being cooked. Therefore, whole-shrimp vegetable fried rice, Korean thistle rice in a hot pot, beef mushroom bibimbap, and seafood vegetable fried rice on an iron grill may be included in products requiring moisture. Therefore, recipe information of whole-shrimp vegetable fried rice, Korean thistle rice in a hot pot, beef mushroom bibimbap, and seafood vegetable fried rice on an iron grill may include content that recommends controlling the magnetron 120 to operate but the heater 130 to not operate by the controller 160, displaying an enameled container or a grill as the type of cooking container by the display 170, and displaying the lowermost stage among the plurality of stages 111 as the position of the cooking container by the display 170. Also, the recipe information of whole-shrimp vegetable fried rice, Korean thistle rice in a hot pot, beef mushroom bibimbap, and seafood vegetable fried rice on an iron grill may include content that recommends additionally displaying a cooking container cover guide phrase by the display 170.

The present specification has been described above with reference to the accompanying drawings, but the present specification is not limited by the embodiments and drawings disclosed herein, and it is apparent that various modifications may be made by those of ordinary skill in the art within the scope of the technical spirit of the present specification. Further, even if effects according to configurations of the present specification have not been explicitly described in the above description of the embodiments of the present specification, predictable effects of the corresponding configurations should also be acknowledged.

1. A cooking device comprising:
a cooking chamber having a plurality of stages formed to store a cooking container;
a magnetron configured to supply microwaves to an inside of the cooking chamber;
a heater configured to apply heat to the inside of the cooking chamber;
a communication device configured to receive, from a server, recipe information that matches product identification information input through a user terminal;
an input device configured to receive an input selecting any one of pieces of pre-stored recipe information of one or more products from a user;
a controller configured to control operations of the magnetron and the heater based on the recipe information received through the communication device or the recipe information selected through the input device; and
a display configured to display a type of the cooking container and a position of the cooking container based on the recipe information received through the communication device or the recipe information selected through the input device.

2. The cooking device of claim 1, wherein the controller controls the magnetron and the heater to operate in a case in which the recipe information received through the communication device or the recipe information selected through the input device is recipe information of a product not requiring moisture.

3. The cooking device of claim 1, wherein the display displays a heat-conducting coated container as the type of the cooking container in the case in which the recipe information received through the communication device or the recipe information selected through the input device is recipe information of a product not requiring moisture.

4. The cooking device of claim 1, wherein the display displays an uppermost stage among the plurality of stages as the position of the cooking container in the case in which the recipe information received through the communication device or the recipe information selected through the input device is recipe information of a product not requiring moisture.

5. The cooking device of claim 1, wherein the controller controls the magnetron to operate but the heater to not operate in a case in which the recipe information received through the communication device or the recipe information selected through the input device is recipe information of a product requiring moisture.

6. The cooking device of claim 1, wherein the display displays a grill or an enameled container as the type of the cooking container in the case in which the recipe information received through the communication device or the recipe information selected through the input device is recipe information of a product requiring moisture.

7. The cooking device of claim 1, wherein the display displays a lowermost stage among the plurality of stages as the position of the cooking container in the case in which the recipe information received through the communication device or the recipe information selected through the input device is recipe information of a product requiring moisture.

8. The cooking device of claim 1, wherein the display additionally displays a cooking container cover guide phrase in the case in which the recipe information received through the communication device or the recipe information selected through the input device is recipe information of a product requiring moisture.

9. The cooking device of claim 1, wherein the display does not display a cooking container cover guide phrase in the case in which the recipe information received through the communication device or the recipe information selected through the input device is recipe information of a product not requiring moisture.

10. The cooking device of claim 1, wherein the display designates the position of the cooking container so that a distance between the cooking container and the heater is minimized in the case in which the recipe information received through the communication device or the recipe information selected through the input device is recipe information of a product not requiring moisture.

11. The cooking device of claim 1, wherein the display designates the position of the cooking container so that a distance between the cooking container and the heater is maximized in the case in which the recipe information received through the communication device or the recipe information selected through the input device is recipe information of a product requiring moisture.
